(19) United States
(12) Patent Application Publication
(10) Pub. No.: US 2021/0384729 A1
(43) Pub. Date: Dec. 9, 2021

(54) ENERGY STORAGE AND ALTERNATING CURRENT POWER COMBINERS

(71) Applicant: Hewlett-Packard Development Company, L.P., Spring, TX (US)

(72) Inventors: Fred Charles Thomas, III, Fort Collins, CO (US); J. Michael Stahl, Fort Collins, CO (US); Adolfo Gomez, Fort Collins, CO (US); Raphael Gay, Fort Collins, CO (US)

(73) Assignee: Hewlett-Packard Development Company, L.P., Spring, TX (US)

(21) Appl. No.: 17/056,875

(22) PCT Filed: Feb. 25, 2019
(86) PCT No.: PCT/US2019/019453

§ 371 Date: Nov. 19, 2020

(51) Int. Cl. H02J 3/32; H02J 7/00

(52) U.S. Cl. CPC H02J 3/32; H02J 7/0068; H02J 7/00714

(57) ABSTRACT

A first alternating current (AC) power may be changed into a direct current (DC) power and stored in an energy storage as stored power. The stored power may be converted into a second AC power and combined with the first AC power.

### BACKGROUND

Power sources may provide power to various loads. Different power sources may have different power specifications for the power they provide. Loads may have time-varying and operational-usage power specifications. A load may have diminished performance or be unable to operate if its power specifications are not met.

### BRIEF DESCRIPTION OF THE DRAWINGS

Various examples will be described below referring to the following figures:

FIG. 1 shows an apparatus that combines power from an alternating current (AC) power source and energy storage in accordance with various examples;

FIG. 2 shows an apparatus that stores energy from an input power terminal and combines the stored energy and power from the input power terminal to output as AC power on an output power terminal in accordance with various examples;

FIG. 3 shows a method of storing energy from an AC power source and combining the stored energy with the AC power in accordance with various examples;

FIG. 4 shows an apparatus with a controller that combines power from an alternating current (AC) power source and energy storage in accordance with various examples;

FIG. 5 shows an apparatus and a controller, with the controller powered as part of a load on the apparatus, with the controller powered as part of a load on the apparatus, where the apparatus combines power from an alternating current (AC) power source and energy storage in accordance with various examples; and

FIG. 6 shows an apparatus with a power sensor and a controller, where the apparatus stores energy from an input power terminal and combines the stored energy and power from the input power terminal in accordance with various examples.

### DETAILED DESCRIPTION

Power sources may be limited in the power they can provide. Power sources may differ in their specifications or in actual use. For example, in the United States a 120 volt alternating current (VAC) electrical outlet from a wall may be able to provide 15 amps (A) of current or 20 A current. Some power sources may vary over time, causing difficulties for equipment using the power. The equipment using the power may also have varying power specifications or may vary over time or operation-usage demands. Some equipment may be specified for a 20 A current draw, while other equipment may be specified at 15 A or less. Equipment may draw lower power over most of their operation but have operational modes that use significantly more power at times. A power source may be capable of supplying multiple pieces of equipment during normal operations, but be unable to meet the power demands once one of the pieces of equipment begins a power demand spike.

An energy storage may be used to store energy from a power source and supplement the power source under various conditions. A power combiner may combine power from the energy storage with power from the power source to provide additional power during a power demand spike by connected equipment. This arrangement may also be used to provide a more stable power supply when the power source is not reliable, such as in cases of power outage or reduced power capacity. Various other use cases may be achieved, such as storing and releasing power based upon the price of power at various times.

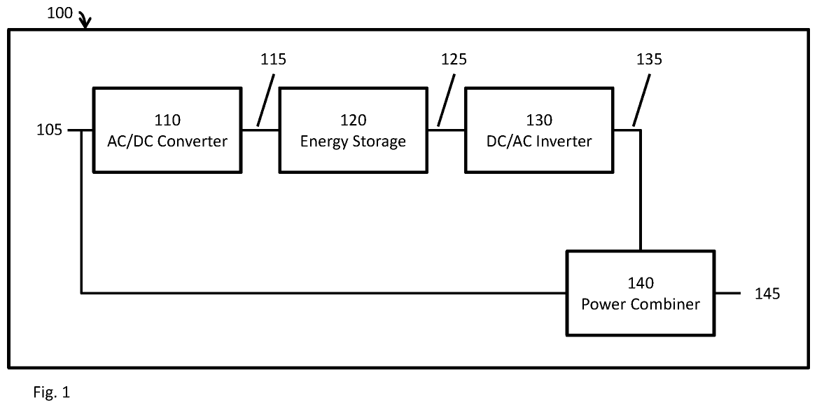

FIG. 1 shows an apparatus 100 that combines power from an alternating current (AC) power source and energy storage 120 in accordance with various examples. The apparatus 100 includes an alternating current to direct current (AC/DC) converter 110, an energy storage 120, a direct current to alternating current (DC/AC) inverter 130, and a power combiner 140. The input of the AC/DC converter 110 is coupled to a power source that can provide alternating current (AC) power 105. The AC/DC converter 110 can change the AC power 105 into DC power 115. The energy storage 120 is coupled to the DC power 115 output of the AC/DC converter 110. The energy storage 120 may change the DC power 115 into stored energy. The energy storage 120 may change the stored energy back into DC power 125. The DC/AC inverter 130 is coupled to the DC power 125 output of the energy storage 120. The DC/AC inverter 130 changes the DC power 125 into AC power 135. The power combiner 140 is coupled to the power source to receive AC power 105. The power combiner 140 is also coupled to the DC/AC inverter 130 to receive AC power 135 that had been stored via the energy storage 120. The power combiner 140 combines the AC power 105 from the power source with the AC power 135 from the DC/AC inverter 130 to generate an augmented AC power 145.

The AC/DC converter 110 may be of various designs. For example, the AC/DC converter 110 may include a forward converter, a flyback converter, or rectification and filtering. The AC/DC converter 110 may be controlled to be disabled at some times and enabled at others. The AC/DC converter 110 may be disabled if the energy storage 120 is at full capacity or due to properties of the AC power 105, such as price at a certain time of day.

The energy storage 120 may be of various designs. For example, the energy storage 120 may include a rechargeable battery, capacitors or supercapacitors, an accumulator, compressed gas, hydrogen, or a flywheel to store energy.

The DC/AC inverter 130 may be of various designs. For example, the DC/AC inverter 130 may include an electromechanical inverter, a pure sine wave inverter, a quasi-sine wave inverter, a push-pull converter, or a transformer. The DC/AC inverter 130 may be a multi-stage design.

The power combiner 140 may include a transformer, electronic switcher technology, or phase and frequency tuners. The phase and frequency tuners may adjust the phase and frequency of the AC power 135 to match the AC power 105, such as through a resistive, inductive, capacitive (RLC) circuit to dynamically tune the AC power 135 through signal conditioning. The power combiner 140 may be designed to combine different power amounts from the AC power 105 from the power source and the AC power 135 that was stored in the energy storage 120. In various examples, the power combiner 140 may be integrated into the DC/AC inverter 130 as part of a grid tie inverter for higher efficiency.

In various examples, a building may receive AC power from a power plant. The AC power may be routed into separate circuits through the building, and the circuits may be protected, such as by circuit breakers. A circuit may be rated to a certain ampere limit, such as 15 A. The circuit breaker may trip if the devices connected to the circuit try to draw a combined total greater than 15 A. A computer workstation may operate at a 3 A current draw during normal operations. The workstation may have a maximum current draw of 15 A, when it is under a heavy workload. While one 15 A circuit may be able to support five workstations operating at 3 A current draws during normal operations, the circuit breaker may trip if one of the workstations enters a heavy workload and tries to draw 15 A. To effectively operate the five workstations and account for power demand application-use driven changes from the workstations, five separate circuits may be wired to the same room, one per workstation. Additional circuits may be used to provide power to monitors, printers, and other power outlets. Use of the apparatus 100 may allow powering of the five workstations from one circuit. The energy storage 120 may store power during times of low power usage by the workstations, such as at night when the workstations may not be in use or when the workstations are working at a reduced load during the day. When one of the workstations has a power demand spike or an extended use, the energy storage 120 may provide DC power 125 to the DC/AC inverter 130. The DC/AC inverter 130 may change the DC power 125 to AC power 135, which may be combined with the AC power 105 from the building's circuit in the power combiner 140. The augmented AC power 145 may be provided to the workstations. If one workstation is trying to draw 15 A of current and the others are operating at 3 A, the DC/AC inverter 130 may provide AC power 135 with approximately 12 A of current to be combined with the circuit's 15 A of current for the AC power 105. The augmented AC power 145 may thus be able to provide 27 A of current, satisfying the power demands of the workstations. Due to inefficiencies of the power combiner 140, the DC/AC inverter 130 may provide slightly more than 12 A for the AC power 135.

In various examples, a 15 A power source may be available, such as a 15 A circuit in a building. This may be insufficient to properly power a computer workstation that may have a 20 A peak current draw. The apparatus 100 may enable use of the computer workstation off of the 15 A power source. While the computer workstation is operating at a current draw less than 15 A, the AC/DC converter 110 may draw the remaining available current. The surplus AC power 105 may be changed and stored in the energy storage 120. The power combiner 140 may pass the AC power 105 through without modification to provide AC power 145 to the computer workstation. When the computer workstation tries to draw more than 15 A of current, the apparatus may switch from storing energy in the energy storage 120 to retrieving energy from the energy storage 120. The AC/DC converter 110 may be disabled. The energy storage 120 may provide DC power 125 to the DC/AC inverter 130, which is changed to AC power 135. The AC power 135 may be combined with the AC power 105 from the power source into an augmented AC power 145 via the power combiner 140. If the computer workstation is trying to draw 18 A, the DC/AC inverter 130 may provide an AC power 135 of approximately 3 A to be combined with the 15 A available via the AC power 105 from the power source.

In various examples, the apparatus 100 may be provided with AC power 105 to be stored in the energy storage 120. There may not be any devices connected to the apparatus 100 to draw AC power 145 at the time. The apparatus 100 may later be disconnected from the AC power 105 input. A device may be connected to the AC power 145 output of the apparatus 100. The apparatus may provide power via the energy stored in the energy storage 120. The power combiner 140 may provide the AC power 135 derived from the energy storage 120 as an output AC power 145 even in the absence of an input AC power 105. This may allow the apparatus 100 to act as a power source in a remote location where power is otherwise unavailable or limited.

In various examples, the apparatus 100 may have stored energy in the energy storage 120. The AC power 105 from the power source may fail due to a power outage. When the AC power 105 fails, the apparatus may switch from storing energy in the energy storage 120 to retrieving energy and changing it to AC power 135 to be provided as an AC power 145 output. The apparatus may also augment the AC power 105 if the AC power 105 has other issues short of a blackout, such as a reduction in the available power.

In various examples, the apparatus may clean up AC power 105 from a power source. A power source may provide AC power 105, but the voltage may vary from a specified voltage value, such as 120 volts root-mean-squared (Vrms), or the frequency may vary from a specified value, such as 60 Hertz. The apparatus may be designed to operate with other AC power specifications, such as 240 volts root-mean-squared and other variations, such as the frequency of the AC power 105. The AC power 105 from the power source may not be within the specifications of a piece of equipment to be powered. The apparatus 100 may be able to correct the AC power 105 and provide a clean AC power 145 that meets the specifications of the equipment to be powered. The correction may include storing energy in the energy storage 120 to be retrieved when the AC power 105 is providing less power. The apparatus 100 may thus be able to account for power demand spikes by the equipment to be powered, as well as current and voltage issues on the AC power 105. This may allow the apparatus 100 to be used in emergency situations, such as setting up a mobile hospital in a disaster area or at a location that has issues with the power infrastructure.

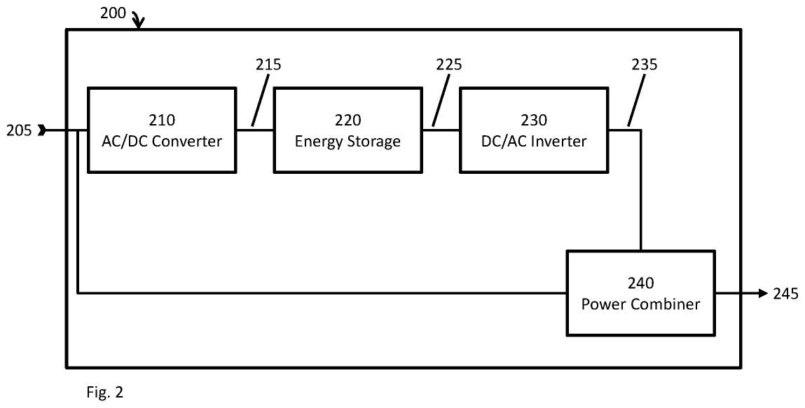

FIG. 2 shows an apparatus 200 that stores energy from an input power terminal 205 and combines the stored energy and power from the input power terminal 205 to output as AC power on an output power terminal 245 in accordance with various examples. The apparatus includes an input power terminal 205, an AC/DC converter 210, an energy storage 220, a DC/AC inverter 230, a power combiner 240, and an output power terminal 245. The input power terminal 205 may receive AC power from a power source. The input power terminal 205 may include a metal plug, receptor, cabling, lug, or wiring. The AC power may be provided by a municipal power grid, a generator, or the alternator of a vehicle. The AC/DC converter 210 is coupled to the input power terminal 205 and converts the AC power into DC power 215. The energy storage 220 is coupled to the AC/DC converter 210. The DC power 215 may be converted and stored as energy in the energy storage 220. The DC/AC inverter 230 is coupled to the energy storage 220. The energy stored in the energy storage 220 may be converted to DC power 225. The DC/AC inverter 230 may convert the DC power 225 into AC power 235. The power combiner 240 is coupled to the DC/AC inverter 230. The power combiner 240 may combine the AC power from the input power terminal 205 with the AC power 235 from the DC/AC inverter 230 and output an AC power to the output power terminal 245. The AC power on the output power terminal 245 may be used to power a load.

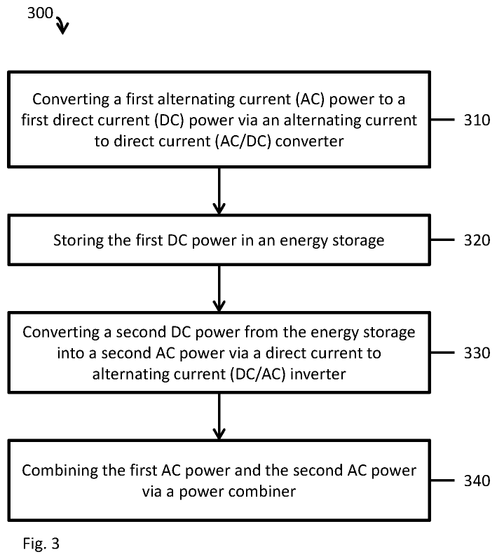

FIG. 3 shows a method 300 of storing energy from an AC power source and combining the stored energy with the AC power in accordance with various examples. The method 300 includes converting a first alternating current (AC) power to a first direct current (DC) power via an alternating current to direct current (AC/DC) converter (310). The method 300 includes storing the first DC power in an energy storage (320). The method 300 includes converting a second DC power from the energy storage into a second AC power via a direct current to alternating current (DC/AC) inverter (330). The method 300 includes combining the first AC power and the second AC power via a power combiner (340).

The power may be stored in an energy storage at one point in time and retrieved from the energy storage at a second point in time based on properties of the first AC power. The properties may include a price of the power, optimization of use/cost cycling by depleting the energy storage, the cleanliness of the power, the stability of the power, availability of power, or third party requests for reduced power consumptions, such as a request form a utility company. For example, if the price of power is changed to account for higher power demands during the day and lower power demands during the night or on weekends, the power may be stored in the energy storage during the nighttime or on weekends. The power may be retrieved from the energy storage during peak power pricing during the day, potentially eliminating the draw on the first AC power during those peak price times.

In various examples, a power sensor may be used to measure attributes of the first AC power, such as the Vrms or current. The power sensor may also measure attributes of the energy storage, such as the amount of stored energy. Based on the measured attributes, the combining of the first AC power and the second AC power may be controlled. For example, a power shortage or outage may be detected, and supplementary power from the energy storage may be combined with the AC power from a wall power outlet to keep the load operating.

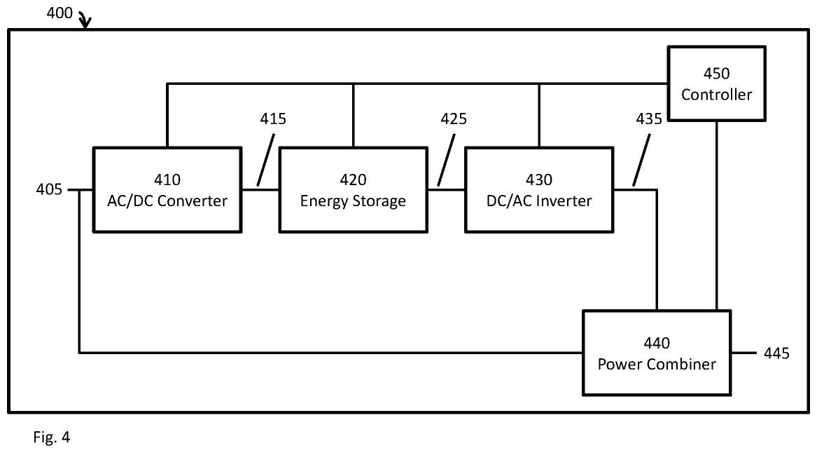

FIG. 4 shows an apparatus 400 with a controller 450 that combines power from an alternating current (AC) power source and energy storage 420 in accordance with various examples. The apparatus includes an AC/DC converter 410, an energy storage 420, a DC/AC inverter 430, a power combiner 440 and a controller 450. The AC/DC converter 410 is coupled to receive an AC power 405. The AC power 405 may come from a wall outlet or a generator. The AC/DC converter 410 may convert the AC power 405 into DC power 415. The energy storage 420 is coupled to the AC/DC converter 410. The energy storage 420 may convert the DC power 415 and store it as energy. The energy storage 420 may retrieve the stored energy and convert it to DC power 425. The DC/AC inverter 430 is coupled to the energy storage 420. The DC/AC inverter 430 may convert the DC power 425 into AC power 435. The power combiner 440 may combine the AC power 405 with the AC power 435 into an AC power 445. The AC power 445 may be provided to a load. The controller 450 is depicted as coupled to the AC/DC converter 410, the energy storage 420, the DC/AC inverter 430, and the power combiner 440. Depending on the design and what the controller 450 is to control, some of the couplings may not exist or be used. The coupling with the controller 450 may be via a bus or via control lines.

The controller 450 may comprise a microprocessor, a microcomputer, a microcontroller, a field programmable gate array (FPGA), or discrete logic.

The controller 450 may control the enablement or disablement of the AC/DC converter 410 and the DC/AC inverter 430. The controller 450 may control whether energy is being stored into the energy storage 420 or retrieved from the energy storage 420. The controller 450 may control how much energy is retrieved from the energy storage 420 and the attributes of the AC power 435 output by the DC/AC inverter 430. For example, the controller 450 may be able to control the DC/AC inverter 430 to provide a 120 Vrms AC power or a 230 Vrms power, corresponding to a United States power system or a European power system. The controller 450 may control how much power is drawn from the AC power 405 versus the AC power 435 that draws on the energy storage 420. Even if the AC power 405 has sufficient power to power a load coupled to AC power 445, the controller 450 may control the apparatus 400 to draw some power from the energy storage 420 via the AC power 435. This control of the power drawn via AC power 405 and AC power 435 may be based on a property of the AC power 405, such as a price per unit, and a property of the energy storage 420, such as the amount of energy stored.

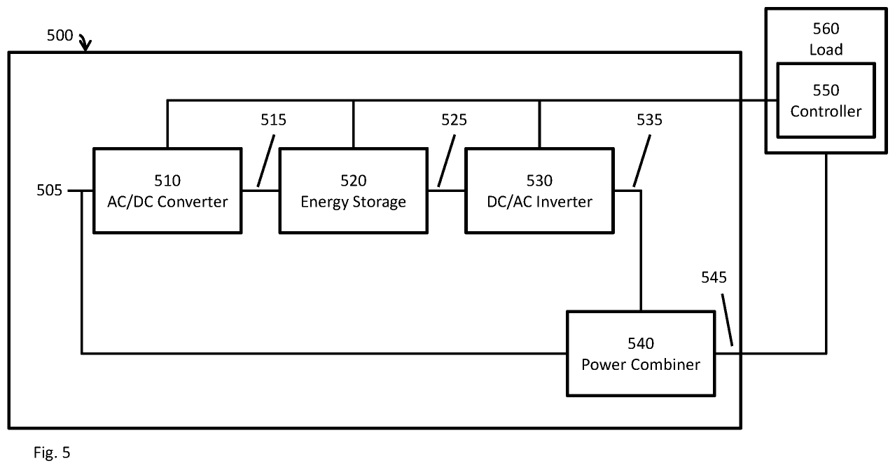

FIG. 5 shows an apparatus 500 and a controller 550, with the controller 550 powered as part of a load 560 on the apparatus 500, where the apparatus 500 combines power from an alternating current (AC) power source and energy storage 520 in accordance with various examples. The apparatus 500 includes an AC/DC converter 510, an energy storage 520, a DC/AC inverter 530, and a power combiner 540. The AC/DC converter 510 is coupled to receive an AC power 505. The AC power 505 may come from a wall outlet or a generator. The AC/DC converter 510 may convert the AC power 505 into DC power 515. The energy storage 520 is coupled to the AC/DC converter 510. The energy storage 520 may convert the DC power 515 and store it as energy. The energy storage 520 may retrieve the stored energy and convert it to DC power 525. The DC/AC inverter 530 is coupled to the energy storage 520. The DC/AC inverter 530 may convert the DC power 525 into AC power 535. The power combiner 540 may combine the AC power 505 with the AC power 535 into an AC power 545. The AC power 545 may be provided to a load 560. The apparatus 500 is coupled to a load 560 on the AC power 545. The load 560 may, for example, be a computer workstation. The load 560 includes a controller 550. The controller 550 is depicted as coupled to the AC/DC converter 510, the energy storage 520, the DC/AC inverter 530, and the power combiner 540. This coupling may be via an external bus or control lines. Depending on the design and what the controller 550 is to control, some of the couplings may not exist or be used. The controller 550 may be powered as part of the load's 560 draw on the AC power 545 provided by the apparatus 500.

In various examples, use of a controller 550 external to the apparatus 500 may allow for better control of the apparatus based on available data. For example, the controller 550 may control the storage and retrieval of energy based on a price of the AC power 505. The utility company may frequently update the price. A controller 550 located in a computer workstation that is also a load 560 to the apparatus 500 may more easily keep track of the updates and modify the control scheme.

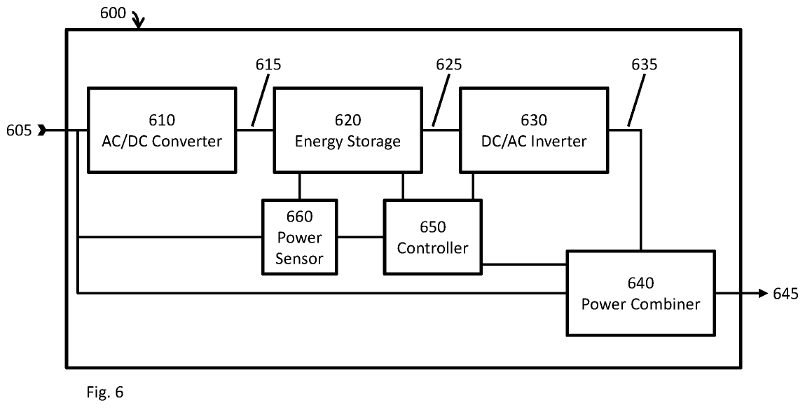

FIG. 6 shows an apparatus 600 with a power sensor 660 and a controller 650, where the apparatus 600 stores energy from an input power terminal 605 and combines the stored energy and power from the input power terminal 605 in accordance with various examples. The apparatus 600 includes an input power terminal 605, an AC/DC converter 610, an energy storage 620, a DC/AC inverter 630, a power combiner 640, a controller 650, a power sensor 660, and an output power terminal 645. The AC/DC converter 610 is coupled to the input power terminal 605. The AC/DC converter 610 may convert AC power from the input power terminal 605 into DC power 615. The energy storage 620 is coupled to the AC/DC converter 610. The energy storage 620 may convert the DC power 615 and store it as energy. The energy storage 620 may retrieve the stored energy and convert it to DC power 625. The DC/AC inverter 630 is coupled to the energy storage 620. The DC/AC inverter 630 may convert the DC power 625 into AC power 635. The power combiner 640 may combine the AC power from the input power terminal 605 with the AC power 635 into an AC power to output via the output power terminal 645. The AC power from the output power terminal 645 may be provided to a load. The power sensor 660 is coupled to the input power terminal 605 and the energy storage 620. The power sensor 660 may measure attributes of the power at the input power terminal 605, such as the Vrms and current. The power sensor 660 may measure attributes of the energy storage 620, such as the amount of energy stored or the capacity that is filled. In various examples, the power sensor 660 may measure other attributes in the system, such as attributes of the DC powers 615, 625, AC power 635, AC power provided to the output power terminal 645, AC power draw on the output power terminal 645, or attributes of the other components of the apparatus 600. The controller 650 is depicted as coupled to the energy storage 620, the DC/AC inverter 630, the power combiner 640, and the power sensor 660. This coupling may be via a bus or control lines. Depending on the design and what the controller 650 is to control, some of the couplings may not exist or be used. In various examples, the controller 650 may also be coupled to the AC/DC converter 610.

In various examples, the power sensor 660 may detect a change in the power of the input power terminal 605. This may allow the controller 650 to determine that a blackout, brownout, power spike or dip, or other condition is occurring. The controller 650 may take appropriate action to ensure a continued supply of power via the output power terminal 645, such as supplementing the power from the input power terminal 605 with power retrieved from the energy storage 620.

In various examples, the controller 650 may communicate with multiple loads and request prioritization of certain loads. The controller 650 may request that a load power down, providing a certain amount of time for the device to perform a controlled shutdown before turning off power delivery to that load.

In various examples, the apparatus 600 may be coupled to multiple loads. The controller 650 may be coupled to communicate with the loads to negotiate a power draw of the loads. The controller 650 may negotiate a power draw with the loads and may prioritize one load over another. The controller 650 may receive a message from a load requesting a higher power allocation for an amount of time. For example, the loads may be five computer workstations that draw 3 A during normal operations. The AC power from the input power terminal 605 may be limited to 15 A. The controller 650 may allocate the computer workstations 3 A for a total of 15 A. One of the workstations may request 15 A for the next five minutes, as it expects to begin a heavy workload. The controller 650 may draw the requested additional power from the energy storage 620. The controller 650 may reduce the power allocation to the other workstations, equally or unequally, to free up 5 A of current and draw the remaining requested power from the energy storage 620. An unequal reduction in power allocations may be based on a relative priority of the workstations. The controller 650 may provide less than the requested 15 A to the requesting workstation.

In various examples, the power combiner 640 may have multiple AC powers output to additional output power terminals. The multiple AC powers may be separately current limited to prevent a load from drawing more than its negotiated power. This may include not providing any power on a particular output power terminal. The multiple AC powers may differ by other characteristics, such as the voltage and frequency of the power. For example, one AC power may provide 120 Vrms power at 60 Hz while another may provide 230 Vrms at 50 Hz. A transformer, switch, or additional power conversion devices may be included to provide such multiple AC powers.

In various examples, the power sensor 660 may detect a higher power draw on the output power terminal 645. In response, the controller 650 may draw energy from the energy storage 620 to make more power available by combining the AC power 635 with AC power from the input power terminal 605 via the power combiner 640.

In various examples, the apparatus 600 may include a DC power input (not shown). The DC power input may be used to charge the energy storage 620. The DC power input may be connected to a vehicle charging system, such as a 12V cigarette lighter for a car. The apparatus 600 may include a DC to DC converter to change the voltage of a DC power provided via the DC power input. The DC to DC converter may be part of a swappable dongle that attaches to the DC power input. The AC/DC converter 610 may be part of a dongle. One dongle may be used to couple to a vehicle's cigarette lighter port and another dongle may be used to couple to a wall outlet that is part of a municipal power grid.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. An apparatus comprising:
an alternating current to direct current (AC/DC) converter to change a first alternating current (AC) power into a direct current (DC) power;
an energy storage coupled to the AC/DC converter, the energy storage to change the DC power into stored energy;
a direct current to alternating current (DC/AC) inverter coupled to the energy storage, the DC/AC inverter to change the stored energy into a second AC power; and
a power combiner coupled to the DC/AC inverter, the power combiner to combine the first AC power and the second AC power into a third AC power.

2. The apparatus of claim 1, wherein the energy storage comprises a battery.

3. The apparatus of claim 1 comprising a controller coupled to the DC/AC inverter and the power combiner, the controller to control a draw of power by the power combiner from the first AC power and the second AC power.

4. The apparatus of claim 3, wherein the controller is to control the draw of power based on a property of the first AC power.

5. The apparatus of claim 3, wherein the controller is part of a load, the load to be powered by the third AC power.

6. An apparatus comprising:
an input power terminal to couple to an alternating current (AC) power supply, the input power terminal to receive a first AC power via the AC power supply;
an alternating current to direct current (AC/DC) converter coupled to the input power terminal, the AC/DC converter to convert the first AC power into a direct current (DC) power;
an energy storage coupled to the AC/DC converter, the energy storage to convert the DC power into a stored energy;
a direct current to alternating current (DC/AC) inverter coupled to the energy storage, the DC/AC inverter to convert the stored energy into a second AC power;
a power combiner coupled to the input power terminal and the DC/AC inverter, the power combiner to combine the first AC power with the second AC power into a third AC power; and
an output power terminal to output the third AC power.

7. The apparatus of claim 6 comprising a power sensor coupled to the input power terminal and the energy storage, the power sensor to detect an energy value stored in the energy storage.

8. The apparatus of claim 7, wherein the power sensor is to detect a change in the power of the input power terminal.

9. The apparatus of claim 8 comprising a controller coupled to the power sensor, the controller to control a draw of power from the energy storage by the power combiner based on the detection of the change in the power of the input power terminal.

10. The apparatus of claim 7, wherein a first current of the first AC power is smaller than a second current of the third AC power.

11. A method comprising:
converting a first alternating current (AC) power to a first direct current (DC) power via an alternating current to direct current (AC/DC) converter;
storing the first DC power in an energy storage;
converting a second DC power from the energy storage into a second AC power via a direct current to alternating current (DC/AC) inverter; and
combining the first AC power and the second AC power via a power combiner.

12. The method of claim 11 comprising:
controlling the storing the first DC power to occur at a first point in time based on a first property of the AC power at the first point in time; and
controlling the converting the second DC power to occur at a second point in time based on a second property of the AC power at the second point in time.

13. The method of claim 11 comprising:
measuring a first attribute of the first AC power via a power sensor;
measuring a second attribute of the energy storage via the power sensor; and
controlling the combining based on the first attribute and the second attribute.

14. The method of claim 11 comprising controlling the second AC power to comprise a first current value to a first load and a second current value to a second load, the sum of the first current value and the second current value to exceed a maximum current of the first AC power.

15. The method of claim 14 comprising:
negotiating the first current value with the first load;
negotiating the second current value with the second load; and
controlling a power draw from the energy storage by the power combiner based on the first current value and the second current value.
